(19) United States
(12) Patent Application Publication
(10) Pub. No.: US 2008/0103637 A1
(43) Pub. Date: May 1, 2008

(54) Method and structures for attaching accessories to an electronic device

(76) Inventors: Robert P. Bliven, Cupertino, CA (US); Chih C. Fang, Cupertino, CA (US); Ray Gradwohl, Los Gatos, CA (US); Jacques Gagne, Los Gatos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,203

(22) Filed: Oct. 30, 2006

(51) Int. Cl. G05D 1/00; G05D 3/00

(52) U.S. Cl. 701/1

(57) ABSTRACT

A housing comprises a track for accepting at least one removably couplable attachment. A portion of an exterior peripheral surface of the housing is recessed relative to adjacent portions of the exterior peripheral surface. The recessed portion and a non-recessed portion of the exterior peripheral surface define a track for interfacing with a removably couplable attachment.

### BACKGROUND

As electronic devices such as computers, video display devices, and keyboards continue to be used more and more in society, users have begun placing an assortment of objects and peripheral devices on or near their electronic devices to enhance their viewing, computing, working, or living experiences. Examples of these accessories include photographs, speakers, business cards, clocks, fans, web cameras, cellular phones, writing utensils, and other objects and devices that may typically be on a desktop or near an electronic device such as a keyboard, computer housing, or video display. A problem associated with these assorted accessories is that they take up space in the area surrounding the electronic device. This creates clutter and potentially uses up valuable workspace, for instance, in an office cubicle or on a desk. Another problem experienced is that it is often difficult to fully utilize or enjoy the benefit of an accessory while simultaneously viewing the electronic device. For instance, it is difficult to simultaneously utilize a web camera for a web-based video interaction while using a video display, unless the web camera is properly positioned and pointed at the user.

A partial solution to these problems is to mount an accessory somewhere on or near the electronic device. However, existing means for doing this have many drawbacks. For instance, a web camera can often be perched atop a video display and pointed at the user. A drawback with this perching approach is that the device can fall off of the video display or easily become misaligned if there is nothing to physically hold it in place.

Another approach is to physically attach the accessory to the electronic device so that it cannot easily fall off. Following such an approach, an accessory or a holder for an accessory can be affixed with an adhesive such as tape, glue, or perhaps even with screw-type fasteners. These mounting solutions provide flexibility in where to initially mount an accessory, but are rather permanent and therefore not readily adjustable if the user dislikes the mounting location or position that was initially chosen. Another drawback is the permanence itself; that is, such a mounting may permanently mark or damage exterior surfaces of an electronic device, especially if the user decides to remove the accessory the mounting for the accessory at some point after it has been installed or mounted. Yet another drawback is that such solutions are unsightly and mar the streamlined appearance, for instance, of a thin video display, monitor, or keyboard.

Yet another solution is a non-permanent clamp-type mounting that grips the front and back sides of an electronic device, such as a flat screen type video display that has a fairly thin profile. One drawback is that a clamp mounted in such a way is unsightly. Another drawback is that in housings, particularly video display housing, potential mounting areas often have sloped sides, thus causing such a clamp type mounting to be unsuitable or to fall off either immediately or gradually over time. Likewise, such a clamp is very unlikely to work interchangeably with another device such as a computer housing. A further drawback of such solutions is that the device housing or display may be damaged, especially if the clamp slides onto the display.

Still another solution is to mount an accessory into a pattern of mounting slots, lugs, or screw holes at a pre-defined location on the housing of an electronic device. The drawback of these mounting methods is that they limit a user to placing only a few select accessories at the few locations on the housing where the mounting is possible. This is undesirable, because it offers the user very little individuality or flexibility in how and where accessories are mounted relative to the electronic device. Further, such a method is cumbersome and may require additional tools to implement.

### DESCRIPTION OF THE DRAWINGS

The accompanying drawings, which are incorporated in and form a part of this specification, illustrate embodiments of the presented technology for methods and structures for attaching accessories to an electronic device and, together with the description, serve to explain the principles of the presented technology. The drawings referred to in this description should not be understood as being drawn to scale unless specifically noted.

FIG. 1 is a front view of a video display device with accessories attached to a peripheral track, according to embodiments.

FIG. 2 is a side view of an exemplary video display device with a track and groove for attaching accessories, in accordance with one embodiment.

FIG. 3 is a three-quarters rear view of a portion of an exemplary video display device with a track and groove for attaching accessories, in accordance with one embodiment.

FIG. 4 is a cross-sectional view of a portion of an exemplary video display device, according to one embodiment.

FIG. 5 is a cross-sectional view of a portion of an exemplary video display device, according to one embodiment.

FIG. 6 is a cross-sectional view of a portion of an exemplary video display device, according to one embodiment.

FIG. 7 is an exemplary accessory clip, in accordance with one embodiment.

FIG. 8 is a cross-sectional view of a portion of an exemplary video display device with an attached accessory clip, according to one embodiment.

FIG. 9 is an exemplary accessory for attaching to an accessory clip, in accordance with one embodiment.

FIG. 10 is an exemplary accessory clip, in accordance with one embodiment.

FIG. 11 is an exemplary accessory clip, in accordance with one embodiment.

FIG. 12A is an exploded view of exemplary accessory clip, in accordance with one embodiment.

FIG. 12B is an assembled front view of the exemplary accessory clip shown in FIG. 12A, in accordance with one embodiment.

FIG. 12C is an assembled rear view of the exemplary accessory clip shown in FIGS. 12A and 12B, in accordance with one embodiment.

FIG. 13 is a cross-sectional view of a portion of an exemplary video display device with an attached accessory clip, according to one embodiment.

### DETAILED DESCRIPTION

Reference will now be made in detail to various embodiments of the presented technology for methods and structures for attaching accessories to an electronic device, examples of which are illustrated in the accompanying drawings. While the technology will be described in conjunction with these embodiments, it will be understood that they are not intended to limit the presented technology to these embodiments. On the contrary, the presented technology is intended to cover alternatives, modifications and equivalents, which may be included within the spirit and scope of the appended claims. Furthermore, in the following description, numerous specific details are set forth in order to provide a thorough understanding.

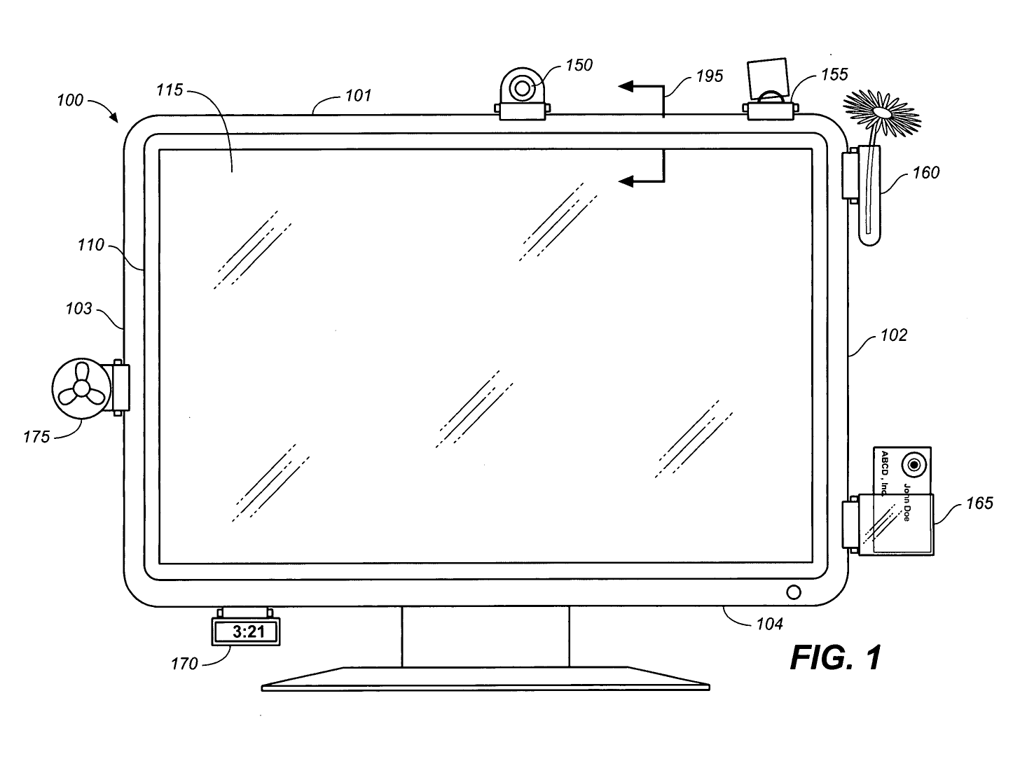

FIG. 1 is a front view of a video display device 100 with removably couplable accessories (150, 155, 160,165, 170, and 175) attached to a peripheral track (not visible in this figure), according to embodiments. As shown in FIG. 1, video display device 100 has a display 115 for displaying moving and still images and a bezel 110 or front portion of a housing that encases the display and associated electronics. Video display device 100 has a top 101, two sides 102 and 103, and a bottom 104. Accessories 150-175 are arrayed on the top 101, bottom 104, and both sides 102 and 103 via accessory attaching structures according to various embodiments. Web camera 150 and photo clip 155 show examples of accessories attached to the top 101 of video display device 100. Tube 160, business card holder 165, and fan 175 show examples of accessories attached to the sides 102 and 103 of video display device 100. Clock 170 shows an example of an accessory attached to the bottom of video display device 100. FIG. 1 demonstrates that the accessory attachment structures (tracks, grooves, and clips) and methods disclosed herein are useful for attaching a variety of accessories at a variety of user-selectable locations around the peripheral edge (101, 102, 103, and 104) of an electronic device such as video display device 100. These structures and methods of attachment give a user flexibly to choose where to attach a particular accessory, and enable the user to easily remove the accessory and easily reattach it at another location.

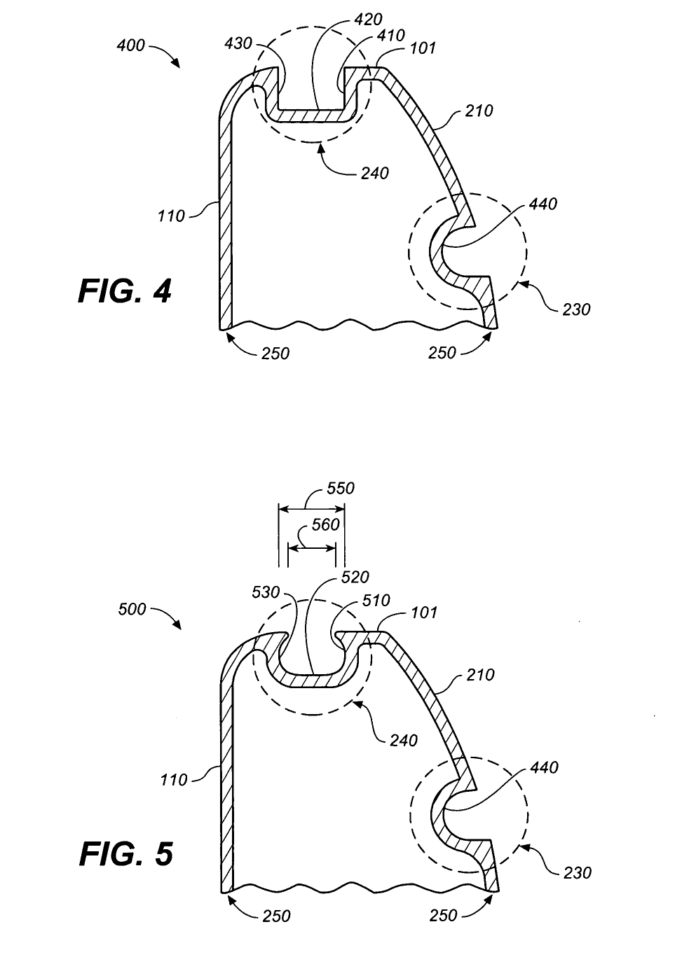

Line and arrows 195 shows the location of a cross-section of video display device 100. FIGS. 4, 5, 6, 8, and 13 show cross-sectional detail views taken on line 195 to show some exemplary alternative configurations of track 240 and optional groove 230.

Video display device 100 and accessories 150-175 are exemplary, and it is appreciated that many other accessories besides those shown in FIG. 1 can be coupled to a video display device, computer case, keyboard, or other electronic device in the manner shown by the exemplary attaching structures, mechanisms, and methods described herein. Additionally, more or less accessories, than those shown, can be used as well. Therefore, while embodiments are shown as particular accessories and structures for attaching to video display device, it is appreciated, that the structures disclosed herein are generally applicable and useful for a variety of electronic devices and a wide variety of accessories. Through uses of the accessory attachment structure and method embodiments disclosed herein, accessories can be easily organized around electronic devices such as: desktop computers, monitors, televisions, notebook computers, keyboards, personal display apparatuses, tablet computers, and other similar devices.

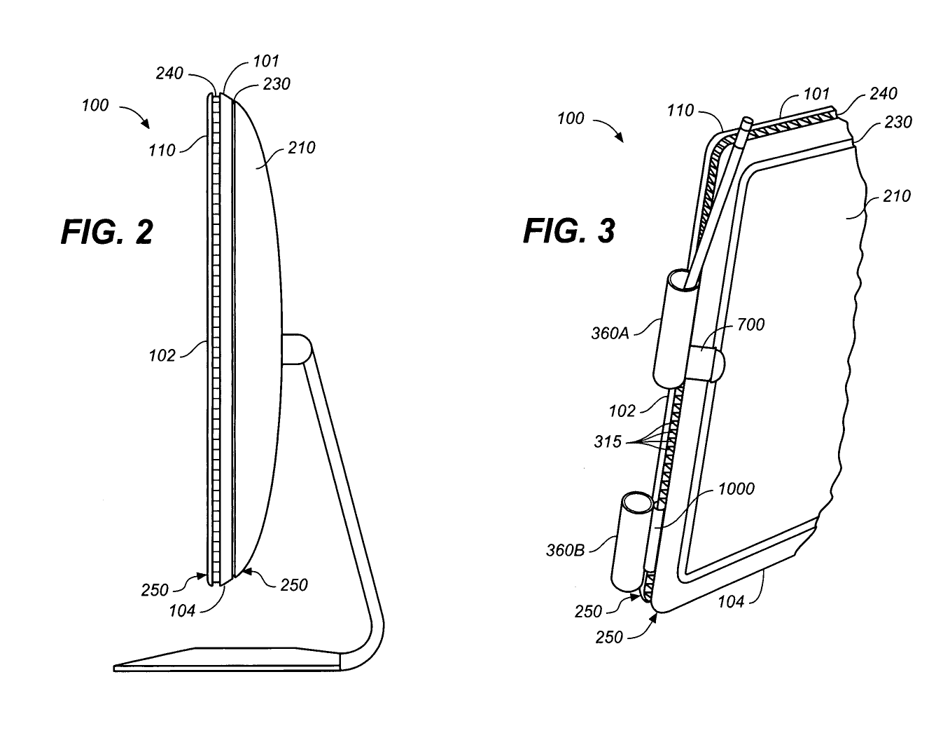

FIG. 2 is a side view of an exemplary video display device 100 with a peripheral track 240 and an optional groove 230 for attaching accessories, in accordance with one embodiment. In FIG. 2, the bezel 110 (front portion) and bucket 210 (rear portion) of the entire housing 250 of video display device 100 are visible. The top 101, bottom 104, and one side 102 of video display device 100 are also visible. Side 103 is symmetrical to side 102. In the displayed embodiment, track 240 and optional groove 230 run continuously around the periphery of video display device 100 (i.e., track 240 and optional groove 230 span the entire length of side 102, and continue uninterrupted across each of top 101, bottom 104, and side 103 (FIG. 1)). In other embodiments, track 240 and optional groove 230 are non-continuous, and exist as a plurality of track segments and groove segments variously located around the exterior peripheral surface of housing 250.

FIG. 2 also shows that track 240 is formed where a portion of the exterior surface of housing 250 is recessed relative to adjacent portions of the exterior peripheral surface of housing 250. For example, in some embodiments, the junction formed between the recessed and non-recessed portions of the exterior peripheral surface of housing 250 defines track 240, which is used for receiving and interfacing with removably couplable attachments. Likewise, optional groove 230 is also formed as a separate recess in the exterior periphery of housing 250, and runs continuously parallel to track 240 around the peripheral exterior surface of housing 250. As shown, track 240 and optional groove 230 circumscribe the exterior peripheral surface of housing 250. In non-continuous embodiments where track 240 and optional groove 230 run in segments, track 240 and groove 230 exist in pairs of segments that run parallel to one another. In yet other embodiments, track 240 is continuous, while groove 230 runs in intermittent sections.

In some embodiments, bezel 110 and bucket 210 are formed as separate parts of housing 250 that are physically coupled at a joint that runs the around the peripheral edge (101,102, 103, and 104) of a video display device. In some such embodiments, this joint is situated within a portion of track 240, thus enabling track 240 to be formed at a normal joining point for the front and rear portions of a housing for a video display device. Placing this joint between bezel 110 and bucket 210 in a portion of track 240 is not required, but is particularly suited for thin screen video display devices of shallow depth (front-to-back). In other embodiments, this bezel/bucket juncture can be located on either side of track 240.

FIG. 3 is a three-quarters rear view of a portion of exemplary video display device 100 with a track 240 and optional groove 230 for attaching accessories, in accordance with one embodiment. In FIG. 3, top 101, bottom 104, and side 102 are visible, as well as bezel 110 and bucket 210 of housing 250. Side 103 (not shown in this Figure) is symmetrical to side 102.

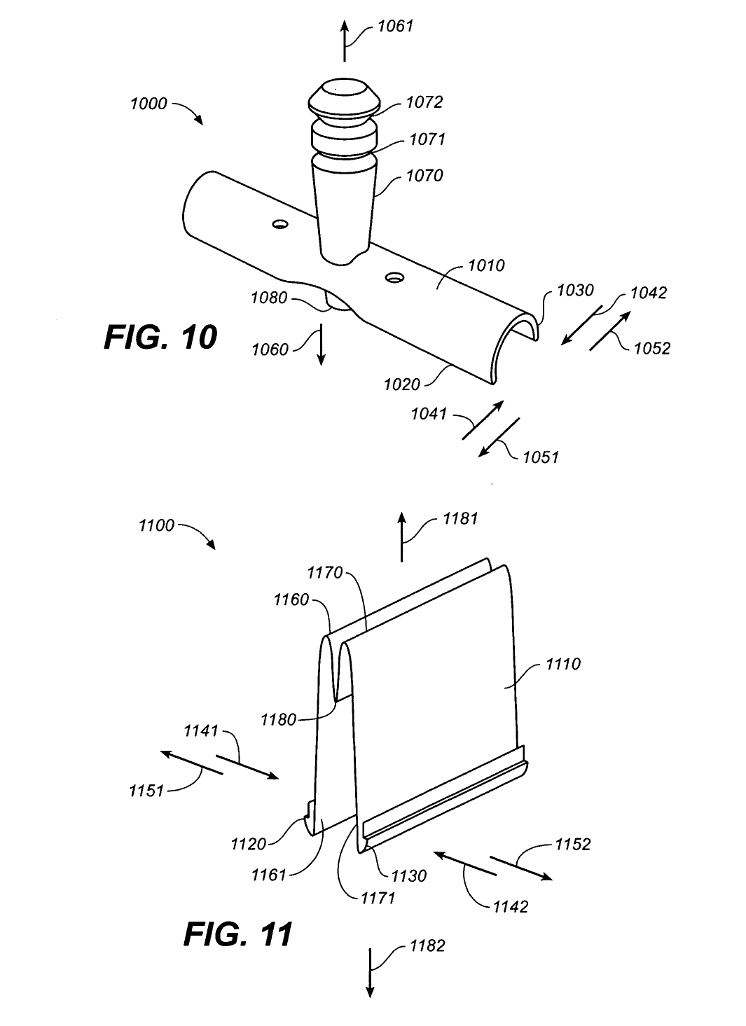

As shown in FIG. 3, accessory tube 360A and accessory tube 360B are attached to side 102 of housing 250. Accessory tube 360A demonstrates a clipping mechanism 700 (FIG. 7) that uses both track 240 and optional groove 230 to removably couple to housing 250. Accessory tube 360B demonstrates a clipping mechanism 1000 (FIG. 10) that utilizes only track 240 to removably couple to housing 250.

Optional indexing stops 315 are also shown within track 240. Indexing stops 315 are formed as series of protrusions within track 240 and are useful to prevent slippage or movement of an accessory that is attached to housing 250. In one embodiment accessory tube 360A and accessory tube 360B are provided with teeth (not visible in FIG. 3) that interface with indexing stops 315 to prevent downward slippage caused by gravity.

FIG. 4 is a cross-sectional view 400 of a portion of an exemplary video display device 100, according to one embodiment. Portions of top 101, bezel 110, and bucket 210 of housing 250 are visible. Additionally, cross-sectional view 400 provides a detail of an exemplary track 240 and optional groove 230. As shown, track 240 is recessed into housing 250. Track 240 is defined as a channel with an open top, a first side 410, a bottom 420, and a second side 430. Optional indexing stops 315 (FIG. 3) are not shown for ease of illustration.

Sides 410 and 430, and bottom 420 all provide surfaces for engaging with clip devices used to attach accessories to housing 250. As shown, sides 410 and 430 are perpendicular to bottom 420, however in other embodiments, either or both sides can be slightly slanted to relative to bottom 420 to form a dovetail or partially dovetail-shaped trapezoidal channel. Additionally, one side 410 or 430 can also be taller than the other. In one embodiment, side wall 410 is utilized as a catch lip for a portion of a clip, such as clip 700 of FIG. 7.

Optional groove 230 is shown as a second recessed portion in the exterior surface of housing 250. The interior surface 440 of groove 230 is curved and configured as a snap groove. In other embodiments, interior surface 440 can comprise other shapes, for instance, with flat sides or with an undercut. Groove 230 provides a surface 440 for engaging a portion of clip that simultaneously interfaces with one or more surfaces in track 240.

FIG. 5 is a cross-sectional view 500 of a portion of an exemplary video display device 100, according to one embodiment. Portions of top 101, bezel 110, and bucket 210 of housing 250 are visible. Additionally, cross-sectional view 500 provides a detail of an exemplary track 240 and optional groove 230. As shown, track 240 is recessed into housing 250. Track 240 is defined as a channel with an open top, a first side 510, a bottom 520, and a second side 530. Optional indexing stops 315 are not shown for ease of illustration.

Sides 510 and 530, and bottom 520 all provide surfaces for engaging with clip devices used to attach accessories to housing 250. As shown, sides 510 and 530 are undercut in a curved radius and bottom 520 is relatively flat. In other embodiments, a single side, such as side 510, can be undercut at a radius, while the other side, 530 for instance, is relatively flat and either perpendicular to or undercut an angle relative to bottom 520. One side 510 or 530 can also be taller than the other. Additionally, in some embodiments, bottom 530 is curved rather than relatively flat as shown in FIG. 5. In one embodiment, side wall 510 is utilized as a catch lip for a portion of a clip, such as clip 700 of FIG. 7.

FIG. 5 illustrates how one or both sides 510 and 530 can be undercut in such a way that the interior dimension 550 of track 240 measured from side 510 to side 530, for instance, is wider than the width 560 of the opening at the top of track 240.

Optional groove 230 is shown as a second recessed portion in the exterior surface of housing 250. The interior surface 440 of groove 230 is curved and configured as a snap groove. In other embodiments, interior surface 440 can comprise other shapes, for instance, with flat sides, or with an undercut. Groove 230 provides a surface 440 for engaging a portion of clip that simultaneously interfaces with one or more surfaces in track 240.

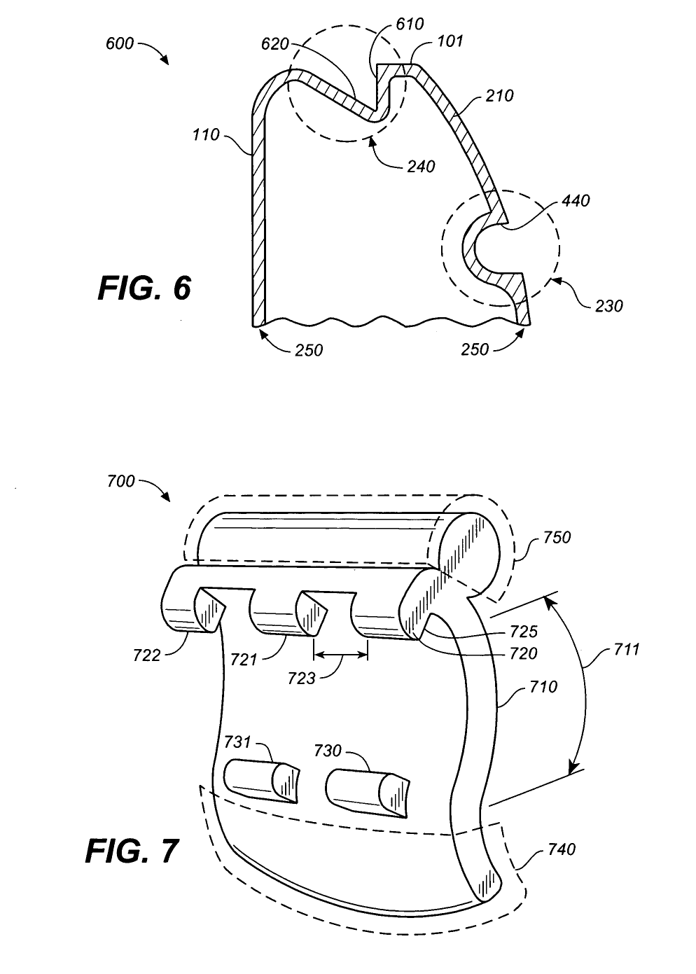

FIG. 6 is a cross-sectional view 600 of a portion of an exemplary video display device 100, according to one embodiment. Portions of top 101, bezel 110, and bucket 210 of housing 250 are visible. Additionally, cross-sectional view 600 provides a detail of an exemplary track 240 and optional groove 230. As shown, track 240 is recessed into housing 250 relative to an adjacent non-recessed area. Track 240 is defined by a single side 610 and a bottom/second side 620. Optional indexing stops 315 are not shown for ease of illustration. In an embodiment as shown in FIG. 6, the sightlines of track 240 will differ slightly from those shown in FIGS. 1-3, and track 240 may be visible in front view.

In FIG. 6, side 610 and bottom 620 provide surfaces for engaging with clip devices (such as clip 700 of FIG. 7) used to attach accessories to housing 250. As shown, side 610 forms a vertical line relative to slanted bottom 620; however, in other embodiments, side 610 can be formed as a slanted undercut or curved undercut relative to bottom 620. Bottom 620 can also be formed as a horizontal bottom, for instance, perpendicular to the vertical side 610 as shown in FIG. 6. In one embodiment, wall side 610 can be utilized as a catch lip for a portion of a clip, such as clip 700 of FIG. 7. Additionally, in some embodiments, bottom 620 can be slightly curved relative to side 610.

Groove 230 is shown as a second recessed portion in the exterior surface of housing 250. The interior surface 440 of groove 230 is curved and configured as a snap groove. In other embodiments, interior surface 440 can comprise other shapes, for instance, with flat sides, or with an undercut. Groove 230 provides a surface 440 for engaging a portion of clip that simultaneously interfaces with one or more surfaces in track 240.

FIG. 7 is an exemplary accessory clip 700, in accordance with one embodiment. Accessory clip 700 is comprised of a main body 710, one or more catch hooks (720, 721, and 722), one or more snap bumps (730 and 731), an optional handle 740, and an optional mounting protrusion such as tongue-shaped mounting protrusion 750.

Main body 710 is rigid or semi-rigid, and in one embodiment is comprised of an injection-molded plastic material. In some embodiments, where an optional mounting protrusion 750 is not utilized, main body 710 is coupled to an accessory, such as accessories 150-175 of FIG. 1.

Catch hooks 720-722 are coupled to main body 710 and are for inserting into a track such as track 240 (FIGS. 5 and 6) defined in the peripheral edge of the exterior surface of an electronic device, such as video display device 100. Each catch hook (720, 721, and 722) has a mating surface, such as surface 725, for interfacing with a surface of a track such as track 240. Space 723 between catch hooks 720 and 721 shows an example of how catch hooks can be spaced apart for interfacing and interlocking with optional indexing stops, such as interface stops 315 shown in FIG. 3.

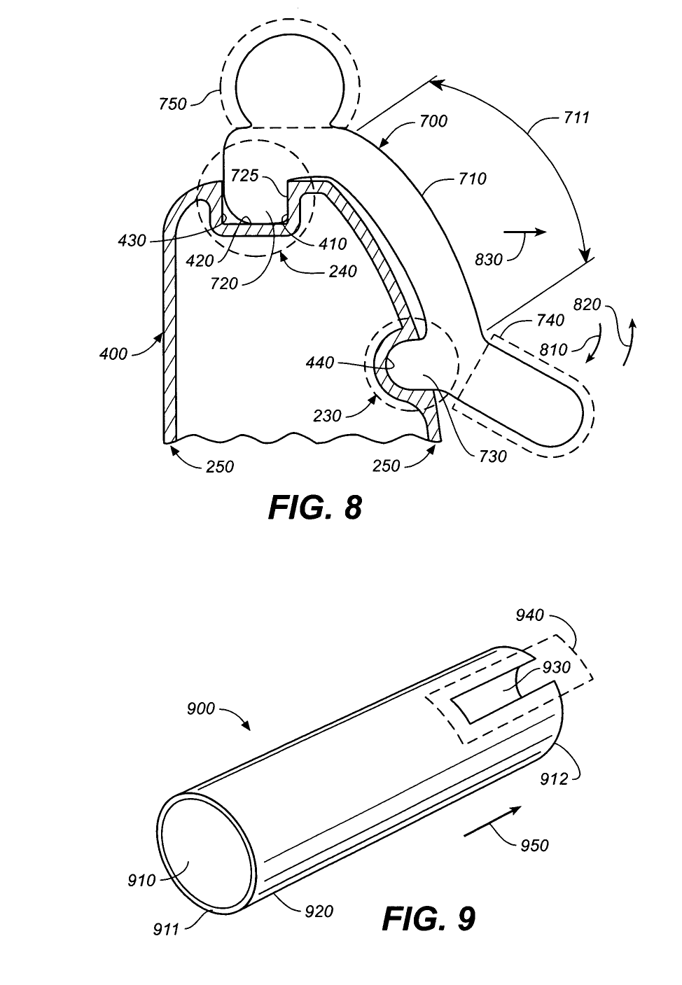

Snap bumps 730 and 731 are coupled to main body 710 and are for interfacing with an exterior surface of the housing of an electronic device, such as video display device 100 (FIG. 3). Snap bumps 730 and 731, as shown in FIG. 7, are particularly configured for interfacing with a snap groove such as groove 230 of FIG. 3. As will be shown in FIG. 8, in one embodiment, the interface between snap groove 230 and snap bumps 730 and 731 can comprise an interference fit. In embodiments of an electronic device that are not configured with an optional groove, snap bumps 730 and 731 can simply interface or rest against any exterior surface of the housing of the electronic device (e.g., bucket 210) when catch hooks 720-722 of clip 700 are attached to a track in the exterior surface of the housing of the electronic device.

Optional handle 740 is coupled to main body 710. In one embodiment, as shown, handle 740 is disposed adjacent to snap bumps 730 and 731. Handle 740 is for providing leverage to engage and disengage snap bumps 730 and 731 from a groove 230 (FIG. 8). This is particularly useful in an embodiment where groove 230 has an interference fit with snap bumps 730 and 731. As shown in FIG. 7, handle 740 is angled relative to main body 710, and is situated at the bottom of clip 700, below snap bumps 730 and 731. The angling of the handle 740 enables users to easily grasp and use the handle without pinching their fingers between the handle 740 and the surface of the electronic interactive device. In other embodiments, handle 740 can be situated at other locations on clip 700.

Optional mounting protrusion 750 is coupled to main body 710. Mounting protrusion 750 is for receiving and removably coupling to a plurality of detachable accessories that are configured to interface with mounting protrusion 750. One such accessory is accessory tube 900 shown in FIG. 9. In FIG. 7, mounting protrusion 750 is configured as a tongue for interfacing with groove-shaped receptacles in a variety of accessories. In other embodiments, the shape of mounting protrusion 750 can be altered to other known shapes for mating of components in a male/female interface fashion.

Main-body 710 is curved for arching over a portion of a housing, such as a sloped portion of the housing of a video display device. The curved portion 711 of main body 710 flexes to provide a spring force for causing a mating surface such as surface 725 to exert a gripping force on a surface such as surface 410 of track 240. An embodiment of this interaction is illustrated in FIG. 8.

FIG. 8 is a cross-sectional view 400 of a portion of an exemplary video display device 100 with an attached accessory clip 700, according to one embodiment.

In FIG. 8, cross-sectional view 400 is the same as cross-sectional view 400 shown and described in FIG. 4. Items 230, 240, 250, 410, 420, 430, and 440 are the same as described in FIG. 4. In FIG. 8, clip 700 is a side view of clip 700 shown and described in conjunction with FIG. 7. Items 710, 711, 720, 725, 730, 740, and 750 are the same as described in conjunction with FIG. 7.

FIG. 8 illustrates how catch hook 720 interfaces with an accessory track surface, such as side 410 of track 240. To attach clip 700 to housing 250, a user first inserts catch hook 720 into track 240 as shown. The user then inserts snap bump 730 into snap groove 230 as shown, by rocking clip 700 in direction 810. Optional handle 740 provides assistance to the user during this insertion process. As shown, snap bump 730 interfaces with surface 440 of snap groove 230 with an interference fit. This tight fit causes the curved section 711 of main body to be 710 to be deflected slightly in direction 810. This creates a spring force tension that pulls face 725 of snap hook 720 in direction 830, causing it to grip side 410 of track 240 very securely. In this configuration, side 410 of track 240 acts as a catch lip for catch hook 720. To remove clip 700 a user rotates clip 700 in direction 820, thus freeing snap bump 730 from snap groove 230 and freeing catch hook 720 to be removed from track 240. Once again, optional handle 740 provides assistance to the user during this removal process. It should be appreciated that in other embodiments, the curved section 711 of main body 710 can be of different lengths and slightly different shapes for spanning shorter or longer distances between a track 240 and a groove 230 and for interfacing with exterior surfaces of different shapes than housing 250.

FIG. 9 is an exemplary accessory for attaching to an accessory clip, in accordance with one embodiment. FIG. 9 shows an accessory tube 900 that is similar to the accessory tubes 360A and 360B shown in FIG. 3. Accessory tube 900 is comprised of a hollow tube with an open end 911 and a closed end 912, an interior surface 910 and an exterior surface 920. A portion of accessory tub 900 comprises a receiving structure 940 for coupling accessory tube 900 to a clip device such as clip 700 (FIG. 7). Receiving structure 940 defines a hollow groove with a surface 930 configured to receive and mechanically couple with a mounting protrusion such as tongue-shaped mounting protrusion 750 in FIG. 7. For instance to couple accessory tube 900 onto clip 700, merely slide receiving structure 940 in direction 950 onto mounting protrusion 750. In other embodiments, receiving structure 940 and surface 930 comprise different shapes and configurations for receiving mounting protrusions of different shapes. Accessory tube 900 is exemplary of an attaching means (940 and 930) that is used to exchangeably couple a wide variety of accessories to a accessory clip such as clip 700.

FIG. 10 is an exemplary accessory clip 1000, in accordance with one embodiment. FIG. 10 is comprised of a shaped compliance surface 1010, a mounting post 1070, and one or more stops 1080. Mounting post 1070 is shown with optional grooves 1071 and 1072 that can be used with or without O-rings (not shown) for coupling with a receiving structure of an accessory. The exterior surface of mounting post 1070 can be ribbed in one embodiment to promote extra friction in the coupling between mounting post 1070 and a receiving structure on an accessory. The exterior surface is comprised of a rough coating in one embodiment, for promoting friction between mounting post 1070 and a receiving structure on an accessory, such as accessories 150-175 of FIG. 1. Shaped compliance surface 1010 defines two slightly deflectable sides or compliance members 1020 and 1030 for interfacing with the sides of a track in an electronic device.

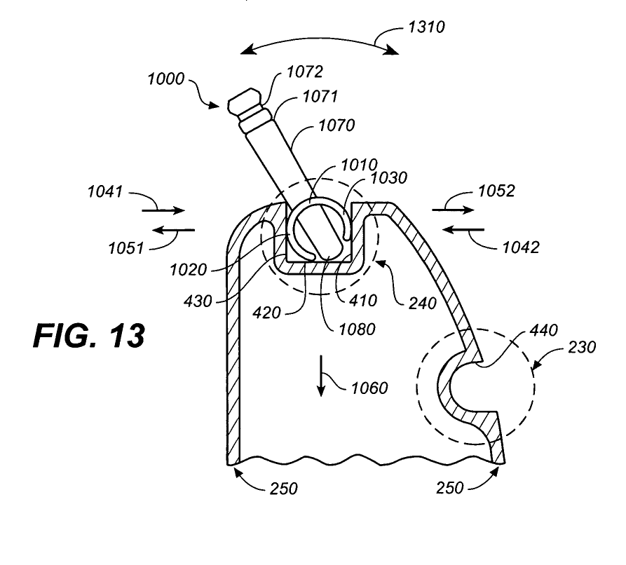

Accessory clip 1000 is designed to be mounted into an accessory attaching track that has slightly smaller internal width than the maximum external width of shaped compliance surface 1010, as measured between sides 1020 and 1030. By inserting accessory clip 1000 in direction of snap 1060 into an accessory attaching track, such as track 240 of FIG. 4, compliance member 1020 is deflected slightly in direction 1041 and compliance member 1030 is deflected slightly in direction 1042. Because of these deflections, compliance member 1020 exerts an outward force in direction 1051 against a wall of the accessory attaching track and compliance member 1030 exerts an outward force in direction 1052 against another side of the accessory attaching track. These outward forces act to securely hold accessory clip 1000 in the accessory attaching track. Stop 1080 interfaces with the bottom of the accessory attaching track to maintain compliance members 1020 and 1030 at a proper level inside the track. An embodiment of this interaction is illustrated in FIG. 13. Accessory clip 1000 is removed from an accessory attaching track by pulling in direction 1061 until clip 1000 comes free from the track. In one embodiment, compliance surface 1010 is coupled directly to an accessory, such as accessories 150-175 of FIG. 1, without the use of mounting post 1070.

FIG. 11 is an exemplary accessory clip 1100, in accordance with one embodiment. Accessory clip 1100 is comprised of a deflectable material such as metal or injection-molded plastic. Accessory clip 1100 is comprised of a main body 1110 that has three bends 1160,1170, and 1180 which form a receiving structure for holding thin objects such as photos or pieces of paper. Accessory clip 1100 is also comprised of two deflectable sides 1161 and 1171 which act as compliance members. Side 1161 has an interface protrusion 1120 and side 1171 has an interface protrusion 1130.

Like accessory clip 1000, accessory clip 1100 is designed to be mounted into an accessory track that has slightly smaller internal width than the maximum external width between interface surfaces 1120 and 1130. By inserting accessory clip 1100 in direction of snap 1182 into an accessory attaching track, such as track 240, compliance member 1161 is deflected slightly in direction 1141 and compliance member 1171 is deflected slightly in direction 1142. The deflections are in response to the compressing force caused by the insertion of accessory clip 1100. Because of these deflections, interface surface 1120 of compliance member 1161 exerts a resilient outward force in direction 1151 against a wall of the accessory attaching track and interface surface 1130 of compliance member 1171 exerts a resilient outward force in direction 1152 against another side of the accessory attaching track. These resilient outward forces act to securely hold accessory clip 1100 in the accessory attaching track. Accessory clip 1100 is removed from an accessory attaching track by pulling in direction 1181 until clip 1100 comes free from the track.

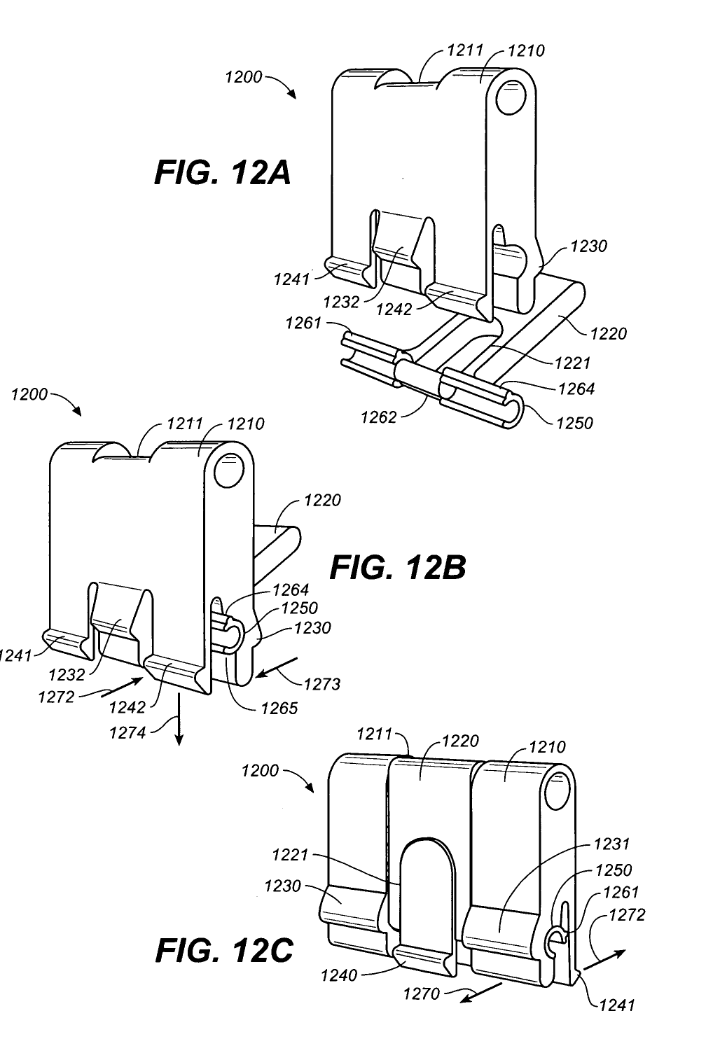

FIG. 12A is an exploded view of an exemplary accessory clip 1200, in accordance with one embodiment. Accessory clip 1200 is shown in a disassembled state in FIG. 12A for easier description. Accessory clip 1200 is comprised of a clamp 1210, a lever 1220, and a camshaft 1250. Clamp 1210 has a first type of deflectable interface tabs 1230, 1231 (FIG. 12C), and 1232, which have protrusions configured to interface at a top portion of an accessory track. Clamp 1210 also has second type of deflectable interface tabs 1240 (FIG. 12C), 1241, and 1242 which have protrusions configured to interface with interior sidewall portions of an accessory track. The two types of interface tabs are alternated on each side of clamp 1210 and act as compliance members for gripping and interfacing with interior sides of accessory attaching tracks, such as track 240. Handle 1220 is coupled to camshaft 1250. Handle 1220 provides leverage for engaging and disengaging cam lobes on camshaft 1250. Handle 1220 defines an opening 1221 that enables handle 1220 to slide over tab 1240 (FIG. 12C) for assembly. Handle 1220 is also configured to fit into depression 1211 when assembled and closed. Camshaft 1250 is configured with cam lobes 1261, 1262, and 1264. Cam lobes 1261, 1262, and 1264 are used respectively to deflect tabs 1241, 1240, and 1242 outward from clamp 1210, when handle 1220 is closed.

FIG. 12B is an assembled front view of an exemplary accessory clip 1200, in accordance with one embodiment. FIG. 12B shows an assembled version of the accessory clip described in FIG. 12A. Items 1210-1265 are the same as described in FIG. 12A, though some are no longer visible. FIG. 12B shows assembled accessory clip 1200 with handle 1220 in an open position, which causes camshaft 1250 to rotate cam lobes 1261,1262, and 1264 such that they do not deflect tabs 1241,1240, and 1242 outward. When handle 1220 is in the open position, as shown, clamp 1200 can be inserted in direction 1274 into an accessory attaching track, such as track 240. Also, with handle 1220 in the open position, tabs 1241, 1232, and 1242 can deflect slightly inward in direction 1272, and tabs 1230,1240, and 1231 can deflect slightly inward in direction 1273 in response to insertion force. This is useful, for instance with accessory track such as accessory track 240 of FIG. 5, where an opening in the accessory track may be narrower than the maximum width measured between exterior surfaces of tabs on opposite sides of clamp 1200 (for example tabs 1242 and 1230).

FIG. 12C is an assembled rear view of exemplary accessory clip 1200, in accordance with one embodiment. FIG. 12C shows the reverse side of an assembled version of the accessory clip described in FIG. 12A and FIG. 12B. Items 1210-1265 are the same as described in FIG. 12A and FIG. 12B, though some are no longer visible. FIG. 12C shows assembled accessory clip 1200 with handle 1220 in a closed position, which causes camshaft 1250 to rotate cam lobes 1261,1262, and 1264 such that they deflect tabs 1241 and 1242 outward in direction 1271, and tab 1240 outward in direction 1270. When handle 1220 is in the closed position, clip 1200 securely grips an accessory track, such as track 240, with the protruding surfaces on tabs 1240-1242. In some embodiments, accessory clip 1200 provides a secure mounting to track 240 for coupling an accessory, such as accessories 150-175 of FIG. 1. To remove accessory clip 1200 from an accessory track, handle 1220 is opened as shown in FIG. 12B, and pulled from the accessory track in a direction opposite of the direction of insertion 1274.

FIG. 13 is a cross-sectional view 400 of a portion of an exemplary video display device 100 with an attached accessory clip 1000, according to one embodiment.

In FIG. 13, cross-sectional view 400 is the same as cross-sectional view 400 shown and described in FIG. 4. Items 230, 240, 250, 410, 420, 430, and 440 are the same as described in FIG. 4. In FIG. 13, clip 1000 is a side view of clip 1000 shown and described in conjunction with FIG. 10. Items 1010,1020,1030, 1041, 1042,1051, 1052, 1060, 1070, 1071,1072, and 1080 are the same as described in conjunction with FIG. 10.

FIG. 13 illustrates how compliance surfaces of a accessory clip, such as compliance members 1020 and 1030 of clip 1000, interface with accessory track surfaces, such as sides 410 and 430 of track 240. To attach clip 1000 to housing 250, a user inserts shaped compliance surface 1010 into track 240, in direction 1060, as shown. The interior width of track 240, as measured between side 410 and 430 is slightly narrower than the maximum width of compliance surface 1010 as measured from the exterior surface of compliance member 1020 to the exterior of compliance member 1030. Upon insertion, this causes compliance surface 1020 to deflect slightly inward in direction 1041, and also causes compliance surface 1030 to deflect slightly inward in direction 1042. This inward deflection causes a spring force in compliance surface 1010 that forces compliance member 1020 to push in direction 1051 against surface 430, and also causes compliance member 1030 to push in direction 1052 against surface 410. Optional groove 230 is not used for coupling a clip such as clip 1000 into an accessory track in some embodiments.

The curved shape of compliance surface 1010 enables clip 1000 to be rocked back and forth in the directions shown (arrows 1310). Rocking is useful, for instance to adjust the angle of a web camera attached to shaft 1070. Stop 1080 interfaces with bottom 420, to keep compliance surface 1010 at a particular height within track 240. Stop 1080 can also bump against a wall (410 or 430) to prevent over rotation (arrows 1310) that would cause clip 1000 to decouple from track 240. Shaft 1070 is tapered in one embodiment so that it is slightly narrower at its base, where it connects to compliance surface 1010. This narrowing enables a few more degrees of rocking before shaft 1070 contacts side 410 or 430 when rocked back-and-forth as shown by arrows 1310.

Track 240 as show in FIG. 13 is exemplary. A clip such as clip 1000 can interface with other track configurations, such as track 240 of FIG. 5, in a similar method to that described in conjunction with FIG. 13. Additionally, in a track such as track 240 of FIG. 5, the curved shape of compliance surface 1000 enables insertion force against a narrowed track opening to cause a compression of compliance surface 1000. The compression enables compliance surface 1000 to fit through the narrowed opening in the top of the track, and then expand to interface with undercut walls 510 and 530. Other clip arrangements can be compressed in a similar fashion to fit through a small opening, or else be manually collapsed, such as by disengaging a cam that forces compliance members apart (as shown in FIG. 12B). Further, it is appreciated that FIG. 13 shows an exemplary method of interfacing with multiple surfaces of an accessory track, such as track 240, and that other clips of different construction, such as clip 1100 or 1200, can utilize different types of compliance members to interface in with an accessory track in a similar fashion.

What is claimed is:

1. A housing comprising:
a track for accepting at least one removably couplable attachment, wherein a portion of an exterior peripheral surface of said housing is recessed relative to adjacent portions of said exterior peripheral surface, and wherein said recessed portion and a non-recessed portion of said exterior peripheral surface define said track for interfacing with said removably couplable attachment.

2. The housing as described in claim 1, wherein said track circumscribes said housing on said exterior peripheral surface.

3. The housing of claim 1, wherein a first wall of said track is configured as a catch lip for interfacing with a catch hook of said removably couplable attachment.

4. The housing of claim 1, further comprising:
a groove defined by a second recessed portion of said housing, wherein said groove is parallel to and separate from said track, and wherein when said removably couplable attachment is coupled to said housing a catch hook of said removable couplable attachment interfaces with a catch lip of said track while a second portion of said removably couplable attachment interfaces with said groove.

5. The housing of claim 1, further comprising a groove defined by a second recessed portion of said housing, wherein said groove is configured as a snap groove for mechanically coupling with a snap bump of said removably couplable attachment.

6. The housing of claim 1, wherein said track comprises stop points for restricting lateral movement of said removably couplable attachment within said track when said removably couplable attachment is coupled to said housing.

7. The housing of claim 1, wherein said track comprises a first wall and a bottom.

8. The housing of claim 7, wherein said track further comprises a second wall and an open top.

9. The housing of claim 7, wherein at least one wall of said track is undercut such that an interior width of said track measured from said first wall to a second wall, is wider than a width of an open top of said track.

10. The housing of claim 1, wherein said removably couplable attachment comprises:
an accessory clip.

11. The housing of claim 1, wherein said removably couplable attachment comprises:
a fan.

12. The housing of claim 1, wherein said removably couplable attachment comprises:
a clock.

13. The housing of claim 1, wherein said removably couplable attachment comprises:
a web camera.

14. The housing of claim 1, wherein said removably couplable attachment comprises:
a business card holder.

15. The housing of claim 1, wherein said removably couplable attachment comprises:
a photograph holder.

16. The housing of claim 1, wherein said removably couplable attachment comprises:
a tube.

17. A clip device for removably attaching to a housing, said clip device comprising:
a semi-rigid main body;
at least one catch hook coupled to said main body, said catch hook for inserting into a track defined in a peripheral edge of said housing;
at least one snap bump coupled to said main body, said snap bump for interfacing with a snap groove of said housing; and
a mating surface disposed on said catch hook, said mating surface for interfacing with a surface of said track.

18. The clip device of claim 17, further comprising:
a handle coupled to said main body and disposed adjacent to said snap bump, wherein said handle is for providing leverage for engaging said snap bump into said snap groove and removing said snap bump from said snap groove.

19. The clip device of claim 17, further comprising:
a mounting protrusion coupled to said main body, wherein said mounting protrusion is for receiving a plurality of detachable accessories configured to mount onto said mounting protrusion.

20. The clip device of claim 17, wherein said semi-rigid main-body is curved for arching over a sloped portion of said housing, and wherein said curved portion of said main body flexes to provide spring force for causing said mating surface to exert a gripping force on a portion of said surface of said track in response to insertion of said snap bump into said snap groove.

21. The clip device of claim 17, wherein snap bump interfaces with an interference fit into said snap groove of said housing.

22. A method of removably coupling an accessory clip into a recessed track defined by an exterior peripheral surface of a housing, said method comprising:
receiving compliance members through an opening in said track; and
engaging sides of said track with said compliance members to secure said accessory clip within said track.

23. The method of claim 22, further comprising:
spreading said compliance members apart from one another with a cam device.

24. The method of claim 22, further comprising:
expanding said compliance members within said track, wherein said expanding is achieved by a resilient force exerted by said compliance members in response to a compressing force applied to said compliance members.

25. The method of claim 22, further comprising:
reducing a portion of said compliance members to a width narrower than said opening.
